(19) United States
(12) Patent Application Publication
(10) Pub. No.: US 2008/0045427 A1
(43) Pub. Date: Feb. 21, 2008

(54) LIQUID FOR FILLING INK SUPPLY SYSTEM OF INK JET DEVICE, METHOD FOR USING THE LIQUID AND THE INK JET DEVICE

(75) Inventors: Yasuyuki HIJIKATA, Tomi-city (JP); Takashi NAMIKI, Tomi-city (JP); Takayuki MITSUI, Tomi-city (JP); Nami SHIMADA, Tomi-city (JP); Isao TABAYASHI, Tomi-city (JP)

Correspondence Address: DITTHAVONG MORI & STEINER, P.C., 918 Prince St., Alexandria, VA, 22314, US

(73) Assignee: Mimaki Engineering Co., Ltd., Tomi-city (JP)

(21) Appl. No.: 11/759,669

(22) Filed: Jun. 7, 2007

(30) Foreign Application Priority Data
Jun. 14, 2006 (JP) 2006-164208

(51) Int. Cl. C11D 3/02

(52) U.S. Cl. 510/108

(57) ABSTRACT

A liquid for filling an ink supply system of an ink jet device includes fluorine series surfactant and an organic solvent which has a boiling point of at least 150° C.

### CROSS-REFERENCE TO RELATED APPLICATIONS

The present application claims priority under 35 U.S.C. §119 to Japanese Patent Application No. 2006-164208, filed Jun. 14, 2006, entitled “Liquid for Filling Ink Supply System.” The contents of this application are incorporated herein by reference in their entirety.

### BACKGROUND OF THE INVENTION

1. Field of the Invention

The present invention relates to a liquid for filling an ink supply system of an ink jet device, a method for using a liquid, and an ink jet device.

2. Discussion of the Background

Since it is required for a lot of time and lobar to adjust discharge of solvent base ink at a place where a printer is set, it is desirable to perform discharge adjustment in advance at the time of shipping the printer. In this case, when conveying the inkjet head with the solvent base ink filling with the solvent base ink, the blockage of the nozzle accompanying the solidification of the solvent base ink will often occur. In order to avoid the blockage, a method can be considered which detracts the solvent base ink and washes the nozzle with a cleaning liquid. However, this method cannot perfectly wash the nozzle and has a problem concerning the solidification of the residual ink.

As a filling liquid for an inkjet head, various fillings have been known, and for example, a filling including a non-volatile organic solvent, especially water-soluble organic solvent and a filling containing water and 1,2-hexane diol have been suggested (Japanese Patent Laid-Open No. 09-327934, and Japanese Patent Laid-Open No. 2004-243543). These fillings are filling substantially used for a water base ink. A filling for inkjet head including non-water solvent containing alcoholic solvent having a boiling point of from 150 to 350° C. aimed at an oil base ink has been suggested (Japanese Patent Laid-Open No. 2005-288728), but it is difficult to avoid the aggregation of pigments in the ink stored over a prolonged period of time and to avoid adherend to nozzle head. An inkjet recording device has been suggested which fill a head with a UV ink from which a photo-curing initiator is removed (Japanese Patent Laid-Open No. 2005-1302), but this technique is for a filling for a UV ink and, thus, is not suitable for an inkjet recording device utilizing a solvent base ink.

As how to cope effectively with the problems described above, a method can be mentioned, which fills an ink supply system with a filling based on an organic solvent having a high boiling point and resembling the component of the solvent of the solvent base ink and which stores and conveys the head. However, this method also has problems associated with instable flying of the ink particles and with non-discharge of ink due to adherend around the nozzle (one of blockage of nozzle).

### SUMMARY OF THE INVENTION

According to one aspect of the present invention, a liquid for filling an ink supply system of an ink jet device includes fluorine series surfactant and an organic solvent which has a boiling point of at least 150° C.

According to another aspect of the present invention, a method for using a liquid includes filling the liquid in an ink supply system of an ink jet device. The liquid includes fluorine series surfactant and an organic solvent which has a boiling point of at least 150° C.

According to further aspect of the present invention, a ink jet device includes an ink supply system and a liquid filling the ink supply system. The liquid includes fluorine series surfactant and an organic solvent which has a boiling point of at least 150° C.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawing, wherein:

FIG. 1 shows a relationship among the amount of the fluorine type surfactant added in the filling liquid for an ink supply system, a viscosity and a surface tension.

### DESCRIPTION OF THE EMBODIMENTS

The embodiments will now be described with reference to the accompanying drawings, wherein like reference numerals designate corresponding or identical elements throughout the various drawings.

In an inkjet device or an inkjet head utilizing a solvent base ink according to an embodiment of the present invention, it has been known that a filling with which an ink supply system is filled instead of the solvent base ink (the filling liquid for an ink supply system) is generally selected from organic solvent having a high boiling point and good compatibility with the solvent base ink, and the organic solvent preferably has a boiling point of not less than 200° C. However, in some cases, after the filling liquid for an ink supply system is substituted with the solvent base ink, the direction of flying the ink particle become instable and, in the worst case, foreign substances are often adhered within or around the nozzle. In particular, even in the case where once the ink supply system is filled with the solvent base ink, the discharge adjustment of the ink head is performed, then the ink supply system is thoroughly washed, and the filling liquid for an ink supply system is incorporated within the ink supply system, this problem occurs significantly, when the washing of the ink supply system is not performed in a perfect manner and the filling is substituted with the solvent base ink after stored or conveyed over a prolonged period of time, and the ink is again discharged.

We have deduced that the caused thereof are as follows: (1) When the conventionally utilized fill for ink supply system is in contact with the solvent base ink, the ink components become instable, adhering them onto the interior of the nozzle of the inkjet head. This results in the generation of cavitation taking the portion to which the ink components are adhered as a core, and in change in the direction of flying the ink particle and the non-discharge of the ink due to the adhered around the nozzle. (2) When the washing liquid including a solvent highly compatible with the solvent base ink (including the organic solvent for the filling according to an embodiment of the present invention, which will be described later on) as a main component is used to wash the ink supply system, particularly the nozzle, the pigments or resins which are components of the ink are adhered onto the interior and/or edge surface of the nozzle due to so-called solvent shock, easily leading to the phenomenon similar to those described under (1). These phenomenons are said to be blockage of the nozzle in a wide sense.

The blockage of the nozzle in the wide sense occurs remarkable, when the ink is a pigment ink.

We have investigated the composition of the filling liquid for an ink supply system in which the ink components becomes instable to minimum when the filling liquid for an ink supply system or the washing liquid is in contact with the solvent base ink, particularly pigment dispersion type ink, to prevent the adhesion of the components onto the interior of the nozzle, and even if the ink components are adhered onto the nozzle, the extent thereof can reduce to minimum. Specifically, when we have tried application of a filling liquid for an ink supply system based on an organic solvent having a high boiling point and resembling a solvent component of the solvent base ink to which various additives (for example, a pigment dispersant, an antioxidant, an amine series stabilizer and the like) and a general surfactant are added, no remarkable improvement has not been obtained. Under such a circumstance, we have discovered that a filling liquid for an ink supply system containing an organic solvent having a boiling point of not less than 150° C., preferably at least 200° C. and fluorine series surfactant has an excellent effect. Different from the general surfactant, it can be considered that due to excellent wetting property, dispersibility with the pigment and washing property possessed by the fluorine surfactant, the prevention of aggregation of the ink remaining within the ink supply system and the pigments contained in the ink during the course of substituting the filling liquid for an ink supply system with the solvent base ink and the prevention of adhesion onto the interior of the nozzle are imparted, and the joint use of the organic solvent having a high boiling point makes the interior of the nozzle always wet even after stored over a long period of time.

The organic solvent component contained in solvent base ink and the organic solvent component contained in the filling liquid for an ink supply system according to an embodiment of the present invention are preferably compatible with each other. More preferably, they are organic solvent components each having resembling chemical structure.

When the organic solvent component contained in the solvent base ink is an organic solvent having a glycol ether group or the like within the chemical structure thereof such as glycol ether, and glycol ether acetate, the filling liquid for an ink supply system according to an embodiment of the present invention is much more preferably contains an organic solvent also having a glycol ether group within the chemical structure thereof.

Examples of an organic solvent having a boiling point of not less than 150° C., preferably at least 200°, making up the filling liquid for an ink supply system, include, but are not restricted to: alcohols such as n-hexyl alcohol (boiling point 153° C.), isoheptyl alcohol (boiling point 168° C.), 2-ethylhexyl alcohol (boiling point 184° C.), n-octyl alcohol (boiling point 194° C.), 3-methyl-3-methoxy butanol (boiling point 174° C.), 3-methoxybutanol (boiling point 160° C.); hydrocarbons such as terpin oil (boiling point 155° C.), limonene (boiling point 178° C.), industrial volatile oil (boiling point 150° C. or more), tetrahydronaphthalene (boiling point 207° C.), and decahydronaphthalene (boiling point 190° C.); glycols such as ethylene glycol (boiling point 197° C.), diethylene glycol (boiling point 244° C.), thiodiethylene glycol (boiling point 168° C.), triethylene glycol (boiling point 287° C.), propylene glycol (boiling point 187° C.), dipropylene glycol (boiling point 232°) and tripropylene glycol (boiling point 265° C.); glycol ether esters such as ethylene glycol monoethyl ether acetate (boiling point 156° C.), ethylene glycol monobutyl ether acetate boiling point 191° C.), diethylene glycol monoethyl ether acetate (boiling point 219° C.), diethylene glycol monobutyl ether acetate (boiling point 238-248° C.), dipropylene glycol monomethyl ether acetate (boiling point 200° C.), and borate of triethylene glycol monomethyl ether (boiling point 275° C.); glycol ethers such as ethylene glycol monohexyl ether (boiling point 208° C.), ethylene glycol 2-ethylhexyl (boiling point 225° C.), ethylene glycol phenyl ether (boiling point 245° C.), propylene glycol monoethyl ether (boiling point 158° C.), propylene glycol propyl ether (boiling point 150° C.), propylene glycol monobutyl ether (boiling point 170° C.), diethylene glycol monomethyl ether (boiling point 194° C.), diethylene glycol dimethyl ether (boiling point 162° C.), diethylene glycol monoethyl ether (boiling point 203° C.), diethylene glycol diethyl ether (boiling point 189° C.), diethylene glycol monobutyl ether (boiling point 230° C.), diethylene glycol hexyl ether (boiling point 260° C.), diethylene glycol 2-ethylhexyl ether (boiling point 270° C.), dipropylene glycol monomethyl ether (boiling point 188° C.), dipropylene glycol monoethyl ether (boiling point 198° C.), dipropylene glycol monobutyl ether (boiling point 215° C.), dipropylene glycol propyl ether (boiling point 210° C.), triethylene glycol monomethyl ether (boiling point 249° C.), triethylene glycol monoethyl ether (boiling point 256° C.), triethylene glycol monobutyl ether (boiling point 271° C.), tripropylene glycol monomethyl ether (boiling point 243° C.), triethylene glycol dimethyl ether (boiling point 216° C.), and tetraethylene glycol dimethyl ether (boiling point 275° C.); esters such as 2,2,4-trimethyl-1,3-pentadiol monoisobutylate (boiling point 253° C.), triethylene glycol di(2-ethyl butylate) (boiling point 181° C.), propylene carbonate (boiling point 242° C.), ethyl lactate (boiling point 155° C.), butyl lactate (boiling point 187° C.), methyl acetoacetate (boiling point 172° C.), ethyl acetoacetate (boiling point 181° C.), dibasic esters DBE(boiling point 205° C.), and 3-methyl-3-methoxybutyl acetate (boiling point 188° C.); ketones such as 2-heptanone (boiling point 151° C.), diisobutyl ketone (boiling point 170° C.), isophorone (boiling point 215° C.), diacetone alcohol (boiling point 168° C.), acetophenone (boiling point 202° C.), cyclohexanone (boiling point 155° C.), γ-butyrolactone (boiling point 204° C.), and 2-(1-cyclohexycenyl)cyclohexanone (boiling point 168° C.); alcohol amines such as triethanol amine (boiling point 335° C.), N-methyldiethanol amine (boiling point 247° C.), N,N-diethylethanol amine (boiling point 163° C.), and N,N-dibutylethanol amine (boiling point 230° C.); organic amines such as tri-n-butyl amine (boiling point 217° C.); and pyrolidones such as N-methyl-2-pyrolidone (boiling point 204° C.). The organic solvents just mentioned are not restricted to the composition of the solvent base ink as long as they are good compatible with the solvent ink. The organic solvents having a high boiling point generally have high viscosity and, thus, they may be combined with an organic solvent having a low boiling point as a diluent.

In the case where the solvent base ink is a glycol ether having a glycol ether group in the chemical structure thereof and where the filling liquid for an ink supply system is a glycol ether having a glycol ether group in the chemical structure thereof, due to its good compatibility, when being combined with the filling liquid for an ink supply system, the filling liquid for an ink supply system according to am embodiment of the present invention exhibits excellent performance, and even if the filling liquid for an ink supply system according to the embodiment of the present invention is substituted with the solvent base ink after being stored and conveyed over a prolonged period of time, change in the direction of flying the ink particle and the non-discharge of the ink based on the blockage in a wide sense as described above never occur.

Amongst the organic solvents described above, the organic amines have a merit of exhibiting prevention of corrosion, if they are added in a small amount, when ink head material easily undergoes corrosion with a trace amount of acid component generated according to the oxidation of the glycol ether type organic solvent or with chlorine ion contaminated in a trace amount

The fluorine series surfactant which is an essential component for the filling liquid for an ink supply system, may be any of anion types, nonion types and cation types, and exemplified compounds include, but are not restricted to, low molecular compounds having fluorine such as perfluoroalkyl sulfonates, ethylene oxide adducts of perfluororoalkyls, trimethyl ammonium salts of perfluoroalkyls, perfluoroalkyl aminosulfonates, oligomers having a perfluoroalkyl group and a lipophilic group in the chemical structure thereof, oligomers having a perfluoroalkyl group and an hydrophilic group in the chemical structure thereof, urethanes having a perfluoroalkyl group and a lipophilic group in the chemical structure thereof, perfluoroalkyl phosphates, perfluoroalkyl carboxylates, perfluoroalkyl amine compounds, quaternary ammonium salts of perfluoroalyls, perfluoroalkyl betains, non-soluble perfluoroalkyl compounds, and fluorine silicone oils

Examples of commercially available fluorine series surfactants includes, but are not restricted to, MRGAFAX® F110, MRGAFAX® F-114, MRGAFAX® F-120, MRGAFAX® F-142D, MRGAFAX® F-144D, MRGAFAX® F-172D, MRGAFAX® F-173, MRGAFAX® F-177, MRGAFAX® F-183, MRGAFAX® F-191, MRGAFAX® F-445, MRGAFAX® F-470, MRGAFAX® F-471, MRGAFAX® F-479, MRGAFAX® F-493, and MRGAFAX® F-494 (available from DAINIPPON INK AND CHEMICALS, INCORPORATED); Flourad FC-93, Flourad FC-95, Flourad FC-129, Flourad FC-170, Flourad FC-171, Flourad FC-430, Flourad FC-431, Flourad EF301, Flourad EF303, and Flourad EF352 (available from Sumitomo 3M Co., Ltd.); F-TOP EF-122B, and F-TOP EF802 (available from Shin Akita Chemicals Co., Ltd.); Asahi Guard AG710, Surflron S-382, Surflron S-382, Surflron SC-101, Surflron SC-102, Surflron SC-103, Surflron SC-104, Surflron SC-105, and Surflron SC-102 (available from Asahi Glass Corporation); BM-1000, and BM-1100 (available from Yosho Co., Ltd.); and NBX-15 (available for NEOS Co., Ltd). They can be used jointly. Amongst them, MRGAFAX® F-114 (anionic type), MRGAFAX® F-445 (nonionic type), MRGAFAX® F-470 (nonionic type), MRGAFAX® F-471 (nonionic type), MRGAFAX® F-479 (nonionic type), MRGAFAX® F-493 (nonionic type), and MRGAFAX® F-494 (anionic type) are preferable in terms of excellent washing ability and pigment dispersibility. In particular, nonionic type fluorine series surfactants are in a liquid form in a single state and, thus, even if the organic solvent component is volatilized, they exhibit a function of preventing the nozzle from being dried to be solid state.

The content of the fluorine series surfactant in the filling liquid for an ink supply system according to the embodiment of the present invention is not specifically restricted, but if it is too small, the effect exhibited by filling the ink supply system is small, and conversely if it is too large, viscosity of the filling liquid for an ink supply system is increased and the viscosity is increased according to volatilization of the organic components in the filling liquid for an ink supply system. Consequently, the content of the fluorine series surfactant is preferably from 10 to 10000 ppm, and more preferably from 10 to 5000 ppm.

The surface tension of the filling liquid for an ink supply system prepared after adding the fluorine series surfactant described above is preferably in the range of from 15 to 26 mN/m.

In the filling liquid for an ink supply system according to the embodiment of the present invention, as occasion demands, organic solvent having a boiling point of not more than 150° C. may be jointly used (mixed). If the ink is a pigment dispersion type solvent base ink, a pigment dispersant, other antioxidant, various stabilizers, and other surfactant may be jointly used (mixed).

The filling liquid for an ink supply system according to the embodiment of the present invention exhibits excellent performance as the filling liquid for an ink supply system unless the solvent base ink and the filling liquid for an ink supply system are compatible with each other. Consequently, the filling liquid for an ink supply system according to an embodiment of the present invention can be applied to various inkjet systems utilizing various solvent base inks.

It is also possible that the ink supply system is washed with a washing liquid having a low viscosity and excellent compatibility with the ink before it is filled with the filling liquid for an ink supply system according to the embodiment of the present invention.

### Examples

Embodiment of the present invention will be described in more detail by referring to working examples. It is however should be noted that the present invention is not restricted to the working examples.

### Example 1

(Preparation)

First, as the filling liquid for an ink supply system according to the embodiment of the present invention, fillings for an ink supply were prepared, comprising an organic solvent having a glycol ether group in the molecule thereof (tetraethylene glycol dimethyl ether (boiling point 275° C.) in an amount of not lower than 50 wt % to which an oligomer having a perfluoroalkyl group, a hydrophilic group, and a lipophilic group in the chemical structure thereof (nonionic type (MEGAFAX® F-494 (available from DAINIPPON INK AND CHEMICALS, INCORPORATED) in an amount of 10 ppm, 100 ppm, 1000 ppm, and 10000 ppm, respectively as a fluorine series surfactant.

As the solvent base ink, which was used, was a pigment dispersion type solvent base ink containing 75 wt % of ethylene glycol methylethyl ether. When the filling liquid for an ink supply system according to the embodiment of the present invention prepared as described above was mixed with the solvent base ink used in Example 1 in a proportion of 1:1, they were compatible with each other, confirming that the filling liquid for an ink supply system in Example 1 had good compatibility.

(Test Upon Real Machine)

A new head was fitted to an inkjet device utilizing a solvent base ink (solvent base ink type inkjet device), and an ink supply system (ink supply tube, and inkjet head (nozzle)) was washed with a washing liquid (diethylene glyxol dimethyl ether). Thereafter, the ink supply system was filled with a solvent base ink, and the discharge adjustment of the inkjet head was performed. Subsequently, the solvent base ink was detracted, and the ink supply system was washed with the washing liquid for a solvent base ink. Subsequently, the ink supply system was filled with the filling liquid for an ink supply system according to the embodiment of the present invention, prepared as described above, and the system was stored at 60° C. for seven days and at −20° C. for 7 days, which elapsed a time under the situations considered to be long term storage and conveying.

Thereafter, the filling liquid for an ink supply system was exhausted out of the ink supply system, and the ink supply system was left standing at a normal temperature for 30 minutes.

Subsequently, the ink supply system was again filled with the solvent base ink, and test drawing and test printing were conducted.

(Evaluation)

(1) It has been confirmed that there was substantially no coming off (non-discharge of ink) and no curve in the tested drawing.

(2) Furthermore, it has been confirmed that there was no strip generated due to instable flying direction of ink particles by a solid printing (phenomenon that the strip visibly appears).

(3) In addition, when the nozzle side (discharge hole) of the inkjet head was microscopically observed it has been confirmed that there was no or little adhesion onto the side of the nozzle (no one of nozzle blockage).

### Comparative Example 1

Example 1 was repeated except that a filling liquid for an ink supply system adding no fluorine series surfactant was used in preparation of Example 1.

As a result, it has been confirmed the non-discharge of ink was remarkable and strips occurred significantly. Also, there was adhesion on the nozzle side (within and around the discharge hole), the head was required to be replaced.

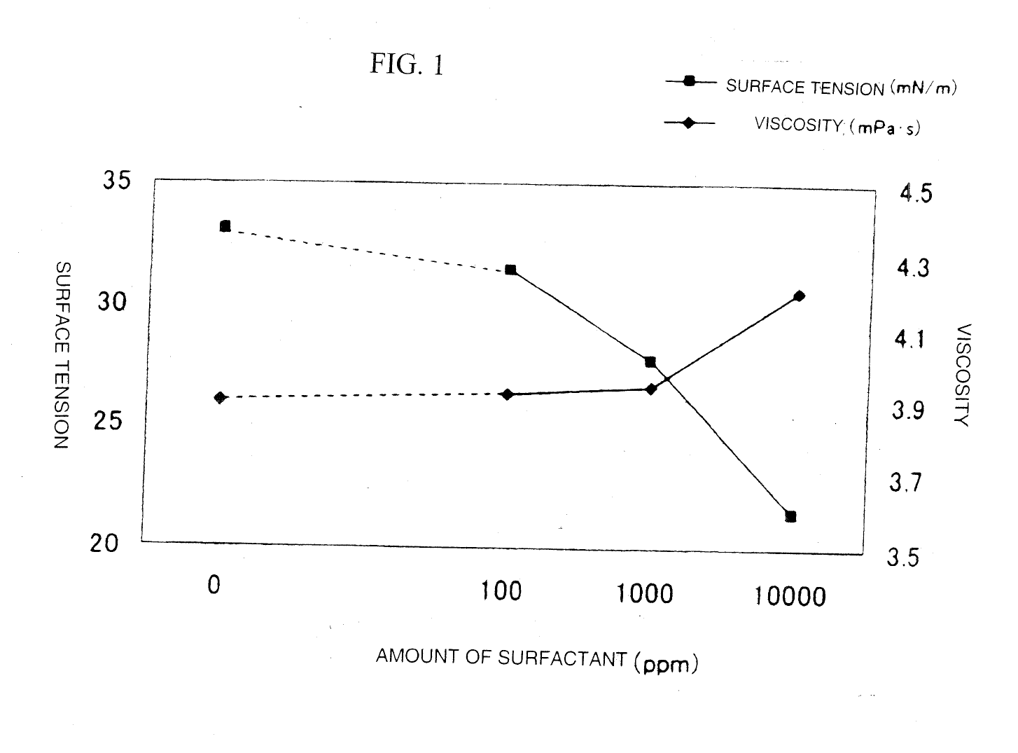

The filling liquids for ink supply system used in Example 1 and Comparative Example 1 were tested for viscosity and surface tension (at a normal temperature of 25° C. The results are shown in FIG. 1 (Change in Physical Properties). It has been understood from FIG. 1 that in comparison with the surface tension of Comparative Example, which was 33.5 mN/M, in which no fluorine series surfactant was added, the surface tension was decreased in Example 1 in which the fluorine series surfactant was added, and particularly, in the case of adding the fluorine series surfactant was added in an amount of approximately 1000 ppm, the surface tension was much more decreased, indicating excellent wetting property. From viewpoint of suppressing the increasing of the viscosity, it has been found that the amount of the fluorine series surfactant was preferably not more than approximately 1000 ppm.

### Example 2

Example 1 was repeated except that tri-n-butyl amine (boiling point 217° C.) was added to the organic solvent used in Example 1 in an amount of 0.1 wt %. This gave similar results.

### Example 3

Example 1 was repeated except that a fluorine series surfactant different from that of Example 1 (fluorine series surfactant containing perfluorobutyl sulfonate: MEGAFACE® F-411 (Anionic type), available from DAINIPPON INK AND CHEMICALS, INCORPORATED) was used as the fluorine series surfactant in the filling liquid for an ink supply system. This gave similar results.

### Example 4

Example 1 was repeated except that a filling liquid for an ink supply system (viscosity: 4.00 mPa·s, surface tension: 25.9 mN/m) containing 1000 ppm of MEGAFACE® F-479 and 1000 ppm of MEGAFACE® F-479 (both available from DAINIPPON INK AND CHEMICALS, INCORPORATED) was used as the fluorine series surfactant instead of single use of MEGAFACE® F-479.111. This gave similar results.

Particularly, no nozzle abnormality could be found after high temperature storage for 7 days at 60° C.

### Example 5

Example 1 was repeated except that an organic solvent different from that of Example 2 (propylene carbonate; boiling point 242° C.) was used as the organic solvent in the filling liquid for an ink supply system. This gave similar results.

### Example 6

Example 1 was repeated except that a pigment dispersant type solvent base ink (an organic solvent comprising a mixture of cyclohexanone, dipropylene glycol dimethyl ether, dipropylene glycol dimethyl ether, and dipropylene glycol methylethyl ether acetate) different from the solvent base ink used in Example 1 was used. This gave similar results.

As described above, the filling liquid for an ink supply system according to the embodiment of the present invention is effectively used in a method for storing and conveying a solvent type inkjet device and a solvent type inkjet head in which the ink supply system is once filled with a solvent base ink, for example, the discharge adjustment of the ink head is performed, the solvent is detracted and the ink supply system is well washed, after which the ink supply system is filled with the filling liquid for an ink supply system, the storage or conveying is performed in this state, then the filling liquid for an ink supply system is exhausted, and then the ink supply system is again filled with the solvent base ink.

In the above-mentioned fact, it is useful as means for avoiding the generation of a phenomenon that a pigment or resin is adhered onto the interior of the nozzle or the edge surface of the nozzle due to so-called solvent shock to wash the ink supply system, particularly, the nozzle, with a washing liquid comprising an organic solvent having a low density and having a high compatibility with the solvent ink (including the organic solvent for the filling liquid for an ink supply system according to the embodiment of the present invention) at the time of detracting the solvent base ink and washing the ink supply system.

The filling liquid for an ink supply system according to the embodiment of the present invention can also be used for the application that before the ink supply system in the solvent type inkjet device or the solvent type inkjet head is first filled with the solvent base ink, the solvent type inkjet device or the solvent type inkjet head is stored or conveyed in the state where the ink supply system is filled with the filling liquid according to the embodiment of the present invention.

Obviously, numerous modifications and variations of the present invention are possible in light of the above teachings. It is therefore to be understood that within the scope of the appended claims, the invention may be practiced otherwise than as specifically described herein.

What is claimed as new and is desired to be secured by Letters Patent of the United States is:

1. A liquid for filling an ink supply system of an ink jet device, the liquid comprising:
an organic solvent having a boiling point of at least 150° C.; and
fluorine series surfactant.

2. The liquid according to claim 1, wherein the organic solvent having a boiling point of at least 200° C.

3. The liquid according to claim 1, wherein the organic solvent includes a glycol ether group, and wherein an ink for the ink jet device includes an organic solvent having a glycol ether group.

4. The liquid according to claim 1, wherein the organic solvent includes organic amines.

5. The liquid according to claim 1, wherein the fluorine series surfactant is anion, nonion or cation.

6. The liquid according to claim 1, wherein the liquid includes fluorine series surfactant of at least 10 ppm and at most 10000 ppm.

7. The liquid according to claim 6, wherein the liquid includes fluorine series surfactant of at most 5000 ppm.

8. The liquid according to claim 1, wherein the liquid has surface tension of at least 15 mN/m.

9. The liquid according to claim 1, further comprising:
an additional organic solvent having a boiling point of less than 150° C.

10. The liquid according to claim 1, wherein the liquid includes at least one of a pigment dispersant, antioxidant and stabilizer.

11. A method for using a liquid, comprising:
filling the liquid in an ink supply system of an ink jet device, the liquid comprising fluorine series surfactant and an organic solvent which has a boiling point of at least 150° C.

12. A ink jet device comprising:
an ink supply system; and
a liquid filling the ink supply system, the liquid comprising:
an organic solvent having a boiling point of at least 150° C.; and
fluorine series surfactant.
